(19) United States
(12) Patent Application Publication
(10) Pub. No.: US 2007/0065737 A1
(43) Pub. Date: Mar. 22, 2007

(54) Multilayer imageable elements having good solvent resistance

(75) Inventors: Anthony P. Kitson, Evans, CO (US); Jianbing Huang, Trumbull, CT (US); Kevin B. Ray, Fort Collins, CO (US)

Correspondence Address: Andrew J. Anderson;Patent Legal Staff, Eastman Kodak Company, 343 State Street, Rochester, NY, 14650-2201, US

(73) Assignee: Eastman Kodak Company

(21) Appl. No.: 11/600,256

(22) Filed: Nov. 16, 2006

Related U.S. Application Data
(63) Continuation-in-part of application No. 11/005,548, filed on Dec. 6, 2004, now abandoned.

(51) Int. Cl. G03C 3/00

(52) U.S. Cl. 430/14

(57) ABSTRACT

Multilayer thermally imageable elements useful as lithographic printing plate precursors are disclosed. The imageable elements comprise a substrate, an underlayer over the substrate, and a top layer over the underlayer. The top layer contains a polymer containing anhydride groups. This polymer is present in the top layer in an amount of at least 60% based on the dry weight of the layer. The imageable elements have excellent resistance to press room chemicals.

### RELATED APPLICATION

This application is a Continuation-in-part of U.S. Ser. No. 11/005,548 filed Dec. 6, 2004 by Kitson et al.

### FIELD OF THE INVENTION

The invention relates to lithographic printing. In particular, this invention relates to multilayer imageable elements useful as lithographic printing plate precursors that have good solvent resistance, and to methods of providing lithographic printing plates therefrom.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. Typically, the ink is first transferred to an intermediate blanket, which in turn transfers the ink to the surface of the material upon which the image is to be reproduced.

Imageable elements useful as lithographic printing plate precursors typically comprise an imageable layer applied over the hydrophilic surface of a substrate. The imageable layer includes one or more radiation-sensitive components, which may be dispersed in a suitable binder. Alternatively, the radiation-sensitive component can also be the binder material. Following imaging, either the exposed regions or the non-exposed regions of the imageable layer are removed by a suitable developer, revealing the underlying hydrophilic surface of the substrate. If the exposed regions are removed, the precursor is positive working. Conversely, if the non-exposed regions are removed, the precursor is negative working. In each instance, the regions of the imageable layer (i.e., the image areas) that remain are ink-receptive, and the regions of the hydrophilic surface revealed by the developing process accept water and aqueous solutions, typically a fountain solution, and repel ink.

Conventional imaging of the imageable element with ultraviolet and/or visible radiation was carried out through a mask, which has clear and opaque regions. Imaging takes place in the regions under the clear regions of the mask but does not occur in the regions under the opaque regions. However, direct digital imaging, which obviates the need for imaging through a mask, is becoming increasingly important in the printing industry. Imageable elements for the preparation of lithographic printing plates have been developed for use with infrared lasers. Thermally imageable, multi-layer elements are disclosed, for example, in Shimazu, U.S. Pat. No. 6,294,311; U.S. Pat. No. 6,352,812; and U.S. Pat. No. 6,593,055; Patel, U.S. Pat. No. 6,352,811; Savariar-Hauck, U.S. Pat. No. 6,358,669, and U.S. Pat. No. 6,528,228; and Kitson, U.S. Patent Application Publication 2004/0067432.

In use, a lithographic printing plate comes in contact with fountain solution. In addition, the printing plate is often subjected to aggressive blanket washes, such as a “UV wash” to remove ultraviolet curable inks. However, many of these systems have limited resistance to either fountain solution and/or aggressive blanket washes. Thus, a need exists for positive working, multi-layer, thermally imageable elements, useful as lithographic printing plate precursors, that have resistance to these solvents.

After thermal imaging, imaged positive-working imageable elements are developed to remove exposed regions of all layers to reveal the hydrophilic substrate. During this step, considerable residue can build up in the developer due to insufficient solubility of removed polymeric binders, particularly polymeric binders from the top layer. Build up of sludge or residue causes a number of maintenance problems besides lowering the useful life of the developer. Thus, there is a need for imageable elements that can be developed to provide lithographic printing plates without a significant buildup of significant residue or sludge in the developer from insolubility of the polymeric binders used in the various element layers, and particularly in the top layer.

### SUMMARY OF THE INVENTION

The present invention provides a positive-working imageable element comprising a photothermal conversion material, a substrate, and an underlayer over the substrate that is removable by an alkaline developer, and an ink receptive top layer over the underlayer, in which:

before thermal imaging, the top layer is dissolvable in an alkaline developer much more slowly than the underlayer,

after thermal imaging to form exposed and non-exposed regions in the element, the exposed regions are more removable by the alkaline developer than the non-exposed regions, and

the top layer comprises a polymeric material comprising recurring units comprising an anhydride, the polymeric material being present in an amount of at least 60 weight % based on topcoat layer dry weight.

This invention also provides a method for forming a lithographic printing plate comprising:
(A) imagewise exposing the positive-working imageable element of this invention to form exposed and non-exposed regions,
(B) contacting the imaged imageable element with an alkaline developer to remove selectively the exposed regions.

Thus, the invention also provides a lithographic printing plate obtained by the noted method.

The imageable elements and the imaged elements prepared therefrom exhibit excellent resistance to the chemicals and solvents used in the preparation and use of lithographic printing plates. In addition, the imageable elements of this invention contain polymeric binders in the outer layer that are very soluble in the developers used for processing. Thus, minimal residue or sludge builds up in the developers. These advantages are achieved by the use of the anhydride-containing polymeric binder in the top layer of the imageable elements. It was surprising that the use of this polymeric binder not only has excellent solubility in the developer but also provides good ink receptivity and developer resistance in the non-exposed regions of the element resulting in good image reproduction.

### DETAILED DESCRIPTION OF THE INVENTION

Unless the context indicates otherwise, in the specification and claims, the terms polymeric material, co-polymer, added polymer, substituted styrene, substituted maleic anhydride, carboxylic acid containing monomer, maleic anhydride polymer, photothermal conversion material, surfactant, and similar terms also include mixtures of such materials. Thus, unless otherwise indicated, the modifiers “a”, “an”, and “the” are not intended to be limited to the singular tense. Unless otherwise specified, all percentages are percentages by weight and all temperatures are in degrees Centigrade (degrees Celsius). Thermal imaging refers to imaging with a hot body, such as a thermal head, or with infrared radiation.

Imageable Element

The invention is an imageable element comprising a substrate (defined below), an underlayer, and a top layer. The element also comprises a photothermal conversion material in various locations as described in more detail below.

Top Layer

Before thermal imaging, the top layer dissolves in an alkaline developer much more slowly than the underlayer. By “much more slowly”, we mean that the time it takes to dissolve the top layer in the alkaline developer is at least 5 times (preferably at least 10 times) the time required for the underlayer to dissolve in the alkaline developer. After thermal imaging, the exposed regions in the element (including the top layer) are more removable by the alkaline developer than the non-exposed regions. The underlayer is also removable by the alkaline developer.

The top layer comprises a polymeric material in an amount of at least 60 weight %, based on the total top layer dry weight. Preferably, the polymeric material is present in an amount of at least 75 weight %, more preferable in an amount of at least 90 weight %, and most preferably in an amount of at least 95 weight %, based on the total top coat dry layer. This polymeric material comprises recurring units comprising an anhydride, as described in more detail below. Preferably, this polymeric binder containing anhydride groups is the only type of polymeric material used as a binder in the top layer but mixtures of this type of polymeric material can be used in this manner.

The top layer may also comprise other ingredients, such as, photothermal conversion materials, dyes or colorants, and surfactants that are conventional ingredients of imageable elements. A surfactant, such as a fluorinated surfactant or a polyethoxylated dimethylpolysiloxane co-polymer, or a mixture of surfactants may be present to help disperse the other ingredients in a coating solvent and/or to act as a coating aid. A dye or colorant may be present to aid in the visual inspection of the imaged or developed element. Printout dyes distinguish the exposed regions from the non-exposed regions during processing. Contrast dyes distinguish the non-exposed regions from the exposed regions in the developed imageable element for example, the resulting lithographic printing plate. The top layer typically consists essentially of the polymeric material and, optionally, one or more photothermal conversion materials, one or more dyes or colorants, and one or more surfactants. When the photothermal conversion material is not present in the top layer, the top layer typically consists essentially of the polymeric material and, optionally, one or more dyes or colorants or one or more surfactants, or one or more colorants and one or more surfactants.

### Polymeric Material

The top layer comprises a polymeric material that is a polymer having recurring groups that include an anhydride group. By “anhydride” we mean both substituted and unsubstituted anhydride groups. The anhydride group is part of the hydrophobic backbone of the polymer.

While the polymeric material can be a homopolymer, it is generally a copolymer that is derived from one or more anhydride-containing monomers and one or more of styrene or styrene derivatives. Thus, mixtures of both types of monomers can be used to prepare the polymeric material.

The polymer having anhydride groups generally has a weight average molecular weight of at least 1,000 and generally from about 1,500 to about 8,000.

The recurring units comprising an anhydride group generally comprise at least 15 mol % and preferably from about 40 to about 60 mol % of the total recurring units in the polymer chain. When styrene or a substituted styrene (derivative), or mixture thereof, is also used to make the polymer, recurring units from styrene or a styrene derivative generally comprise at least 15 mol % and up to 85 mol % of the total recurring units in the polymer chain. Recurring units of additional monomers, such as acrylate and methacrylate monomers, such as methyl acrylate, ethyl acrylate, ethyl methacrylate, butyl acrylate, and butyl methacrylate; acrylonitrile; methacrylonitrile; methacrylamides, such as methacrylamide and N,N-dimethyl methacrylamide; and acrylamides, such as acrylamide and N,N-dimethyl acrylamide, may also be present to provide less than 20 mol % of the recurring units. Preferably, such additional recurring units are not present and the co-polymer consists essentially of recurring units having an anhydride group and recurring units derived from styrene or substituted styrene.

The styrene or styrene derivatives can be defined also using the formula CHR═CR¹(C₆H₄R²) in which R and R¹ are independently hydrogen or a substituted or unsubstituted alkyl group having 1 to 6 carbon atoms. Preferably R and R¹ are independently hydrogen or substituted or unsubstituted methyl (such as methyl and chloromethyl).

The substituent R² may be o-, m-, or p- to the vinyl (CH₂═CH—) group in the monomer. R² can be hydrogen, halogen, hydroxyl, cyano, sulfonamide, substituted or unsubstituted alkyl groups having 1 to 6 carbon atoms, substituted or unsubstituted alkoxyl groups having 1 to 6 carbon atoms, substituted or unsubstituted acyl groups having 1 to 7 carbon atoms, substituted or unsubstituted acyloxy groups having 1 to 7 carbon atoms, or substituted or unsubstituted carboalkoxy groups having 1 to 7 carbon atoms. Halogen includes fluoro (F), chloro (Cl), and bromo (Br). An example of a sulfonamide group is —SO₂NH₂. Alkyl groups of one to six carbon atoms, include but are not limited to, methyl, chloromethyl, methoxymethyl, ethyl, n-propyl, iso-propyl, n-butyl, sec-butyl, iso-butyl, t-butyl, n-pentyl, iso-pentyl, neo-pentyl, n-hexyl, iso-hexyl, 1,1-dimethyl-butyl, 2,2-dimethyl-butyl, cyclopropyl, cyclobutyl, cyclopentyl, methylcyclopentyl, and cyclohexyl. Alkoxy groups of 1 to 6 carbon atoms are —OR³ groups in which R³ is a substituted or unsubstituted alkyl group of 1 to 6 carbon atoms, such as are listed above. Examples include but are not limited to methoxy, ethoxy, n-propoxy, iso-propoxy, n-butoxy, and t-butoxy. Acyl groups of 1 to 7 carbon atoms are —C(O)R³ groups in which R³ is a substituted or unsubstituted alkyl group of 1 to 6 carbon atoms, such as are listed above. Examples include but are not limited to CH₃CO— (acetyl), CH₃CH₂CO—, CH₃(CH₂)₂CO—, CH₃(CH₂)₃CO—, (CH₃)₃CCO—, and (CH₃)₃CCH₂CO—. Acyloxy groups of 1 to 7 carbon atoms are —OC(O)R³ groups in which R³ is a substituted or unsubstituted alkyl group of 1 to 6 carbon atoms, such as are listed above. Examples include but are not limited to H₃CC(O)O— (acetyloxy), CH₃CH₂C(O)O—, CH₃(CH₂)₂C(O)O—, CH₃(CH₂)₃C(O)O—, (CH₃)₃CC(O)O—, and (CH₃)₃CCH₂C(O)O—. Carboalkoxy groups of 1 to 7 carbon atoms are —CO₂R³ groups in which R³ is an alkyl group of 1 to 6 carbon atoms, such as are listed above. Examples include but are not limited to —CO₂CH₃, (carbomethoxy), —CO₂CH₂CH₃ (carboethoxy), —CO₂(CH₂)₂CH₃, —CO₂(CH₂)₃CH₃, —CO₂C(CH₃)₃ (carbo-t-butoxy), —CO₂CH₂C(CH₃)₃, —CO₂(CH₂)₄CH₃, and —CO₂(CH₂)₅CH₃. Preferably, R² is hydrogen or a substituted or unsubstituted methyl.

A most preferred monomer represented by the noted formula is styrene but other useful styrene derivatives such as 4-methylstyrene, α-methylstyrene, and β-methylstyrene are demonstrated in the Examples below.

While R² is shown in the noted formula as a single substituent on the phenyl group, it is contemplated that up to 4 of the same or different R² groups can be attached to the phenyl group in the monomers. Thus, a mixture of the same or different R² groups can be present.

### Preparation of the Polymers

The polymers containing anhydride groups may be prepared by free radical polymerization. In a typical preparation, one or more monomers are polymerized to produce the polymer. Free radical polymerization is well known to those skilled in the art and is described, for example, in Chapters 20 and 21, of Macromolecules, Vol. 2, 2nd Ed., H. G. Elias, Plenum, New York, 1984. Useful free radical initiators are peroxides such as benzoyl peroxide, hydroperoxides such as cumyl hydroperoxide and azo compounds such as 2,2′-azobis(isobutyronitrile) (AIBN). Chain transfer agents, such as dodecyl mercaptan, may be used to control the molecular weight of the compound. Suitable solvents for free radical polymerization include liquids that are inert to the reactants and which will not otherwise adversely affect the reaction, for example, water; esters such as ethyl acetate and butyl acetate; ketones such as methyl ethyl ketone, methyl isobutyl ketone, methyl propyl ketone, and acetone; alcohols such as methanol, ethanol, iso-propyl alcohol, n-propanol, 1-methoxyethanol (Methyl CELLOSOLVE®), n-butanol; ethers such as dioxane and tetrahydrofuran; amides, such as, N,N-dimethylformamide and N,N-dimethylacetamide, and mixtures thereof.

### Added Polymer

One or more other added polymers may also be present in the top layer. When present, the added polymer comprises about 0.1 wt % to about 20 wt %, preferably about 1 wt % to about 20 wt % of the top layer, based on total top layer dry weight. The added polymer is typically a phenolic resin, such as a novolac resin, a resole resin, or a polyvinyl phenol. When present, the preferred added polymers are novolac resins.

Novolac resins are commercially available and are well known to those skilled in the art. They are typically prepared by the condensation reaction of a phenol, such as phenol, m-cresol, o-cresol, p-cresol, etc, with an aldehyde, such as formaldehyde, paraformaldehyde, acetaldehyde, etc. or ketone, such as acetone, in the presence of an acid catalyst. The weight average molecular weight is typically about 1,000 to 15,000. Typical novolac resins include, for example, phenol-formaldehyde resins, cresol-formaldehyde resins, phenol-cresol-formaldehyde resins, p-t-butylphenol-formaldehyde resins, and pyrogallol-acetone resins. Solvent soluble novolac resins having a weight average molecular weight of at least 10,000; solvent soluble m-cresol/p-cresol novolac resins that comprises at least 10 mol % p-cresol and have a weight average molecular weight of at least 8,000; and mixtures thereof may be particularly useful.

Underlayer

The underlayer is between the top layer and the substrate. It is over the substrate and, typically, directly on the substrate. The underlayer comprises a polymeric material that is removable by the developer, and preferably soluble in the developer. In addition, the polymeric material is preferably insoluble in the solvent used to coat the top layer so that the top layer can be coated over the underlayer without dissolving the underlayer. Other ingredients, additional polymers, photothermal conversion materials, and surfactants, may also be present in the underlayer. Useful polymeric materials include carboxy functional acrylics, vinyl acetate/crotonate/vinyl neodecanoate co-polymers phenolic resins, maleated wood rosin, and combinations thereof. Underlayers that provide resistance both to fountain solution and aggressive washes are disclosed in Shimazu, U.S. Pat. No. 6,294,311, incorporated herein by reference.

Particularly useful polymeric materials are polyvinylacetals and co-polymers that comprise N-substituted maleimides, especially N-phenylmaleimide; methacrylamides, especially methacrylamide; and acrylic and/or methacrylic acid, especially methacrylic acid. The preferred polymeric materials of this type are co-polymers of N-phenylmaleimide, methacrylamide, and methacrylic acid, more preferably those that contain about 25 to about 75 mol %, preferably about 35 to about 60 mol % of N-phenylmaleimide; about 10 to about 50 mol %, preferably about 15 to about 40 mol % of methacrylamide; and about 5 to about 30 mol %, preferably about 10 to about 30 mol %, of methacrylic acid. Other hydrophilic monomers, such as hydroxyethyl methacrylate, may be used in place of some or all of the methacrylamide. Other alkaline soluble monomers, such as acrylic acid, may be used in place of some or all of the methacrylic acid. These polymeric materials are soluble in a methyl lactate/methanol/dioxolane (15:42.5:42.5 wt %) mixture, which can be used as the coating solvent for the underlayer. However, they are poorly soluble in solvents such as acetone and toluene, which can be used as solvents to coat the top layer over the underlayer without dissolving the underlayer. The bakeable underlayers disclosed in U.S. Pat. No. 6,893,783 (Kitson et al.) and U.S. Pat. No. 7,049,045 (Kitson et al.), both of which disclosures are incorporated herein by reference, may also be used.

The underlayer may also comprise one or more other polymeric materials, provided addition of these polymeric materials does not adversely affect the chemical resistance and solubility properties of the underlayer. Preferred other polymeric materials, when present, are novolac resins, which may be added to improve the run length of the printing member by a post-development bake process.

### Photothermal Conversion Materials

Imageable elements that are to be imaged with infrared radiation typically comprise an infrared absorber, known as a photothermal conversion material. Photothermal conversion materials absorb radiation and convert it to heat. The photothermal conversion material may be present in the underlayer and/or a separate absorber layer between the top layer and the underlayer. Although a photothermal conversion material is not necessary for imaging with a hot body, imageable elements that contain a photothermal conversion material may also be imaged with a hot body, such as a thermal head or an array of thermal heads. Preferably, the photothermal conversion material is in the underlayer and more preferably, it is only in the underlayer.

The photothermal conversion material may be any material that can absorb radiation and convert it to heat. Suitable materials include dyes and pigments. Typical pigments include, for example, carbon black, Heliogen Green, Nigrosine Base, iron(III) oxide, manganese oxide, Prussian Blue, and Paris Blue. The size of the pigment particles should not be more than the thickness of the layer that contains the pigment. Preferably, the size of the particles will be half the thickness of the layer or less.

The photothermal conversion material may be a dye with the appropriate absorption spectrum and solubility. Dyes, especially dyes with a high extinction coefficient in the range of 700 nm to 1200 nm, are preferred. Examples of suitable dyes include dyes of the following classes: methine, polymethine, arylmethine, cyanine, hemicyanine, streptocyanine, squarylium, pyrylium, oxonol, naphthoquinone, anthraquinone, porphyrin, azo, croconium, triarylamine, thiazolium, indolium, oxazolium, indocyanine, indotricarbocyanine, oxatricarbocyanine, phthalocyanine, thiocyanine, thiatricarbocyanine, merocyanine, cryptocyanine, naphthalocyanine, polyaniline, polypyrrole, polythiophene, chalcogenopyryloarylidene and bis(chalcogenopyrylo)polymethine, oxyindolizine, pyrazoline azo, and oxazine classes. Absorbing dyes are disclosed in numerous publications, for example, Nagasaka, EP 0,823,327; DeBoer, U.S. Pat. No. 4,973,572; Jandrue, U.S. Pat. No. 5,244,771; Patel, U.S. Pat. No. 5,208,135; and Chapman, U.S. Pat. No. 5,401,618. Other examples of useful absorbing dyes include: ADS-830A and ADS-1064 (American Dye Source, Montreal, Canada), EC2117 (FEW, Wolfen, Germany), Cyasorb IR 99 and Cyasorb IR 165 (Glendale Protective Technology), Epolite IV-62B and Epolite III-178 (Epoline), SpectraIR 830A and SpectraIR 840A (Spectra Colors), as well as IR Dyes A, B, and C, whose structures are shown as follows.

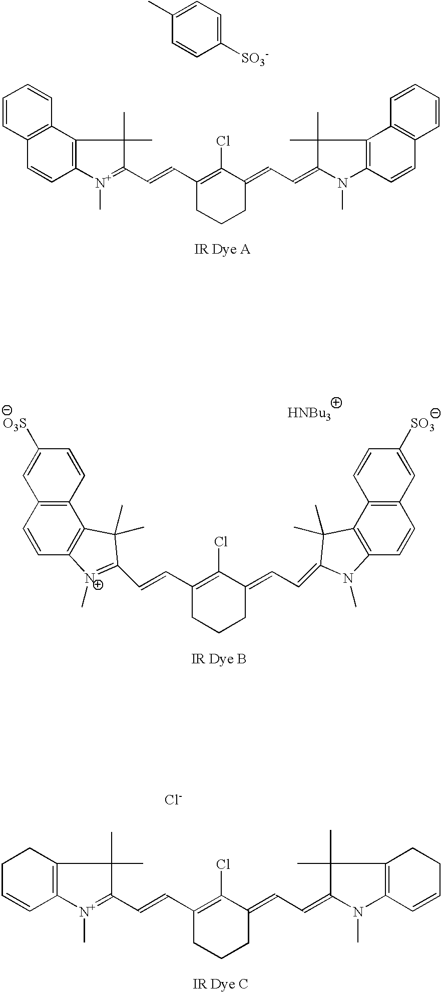

Water-soluble photothermal conversion materials include, for example, cyanine dyes that have one or more sulfate and/or sulfonate groups. Other infrared absorbing cyanine anions that contain two to four sulfonate groups are disclosed, for example, in West, U.S. Pat. No. 5,107,063; Pearce, U.S. Pat. No. 5,972,838; Chapman, U.S. Pat. No. 6,187,502; Fabricius, U.S. Pat. No. 5,330,884; and Japanese Kokai 63-033477. The preparation of cyanine dyes with polysulfonate anions is disclosed, for example, in U.S. Patent Application Publication 2005/0113546 (Tao et al.), the disclosure of which is incorporated herein by reference. The preparation of N-alkyl sulfate cyanine compounds is disclosed, for example, in U.S. Pat. No. 7,018,775 (Tao), the disclosure of which is incorporated herein by reference.

The amount of photothermal conversion present in the element is generally sufficient to provide an optical density of at least 0.05, and preferably, an optical density of from about 0.5 to at least about 2 to 3 at the imaging wavelength. As is well known to those skilled in the art, the amount of compound required to produce a particular optical density at a particular wavelength can be determined using Beer's law. Although the amount present will depend on the compound or compounds chosen, when the photothermal conversion material is only present in the underlayer, it typically comprises about 0.2 wt % to about 8 wt %, more typically about 0.5 wt % to about 4 wt % of the underlayer.

Other Layers

The photothermal conversion material may be present in a separate absorber layer. When an absorber layer is present, it is between the top layer and the underlayer. The absorber layer preferably consists essentially of the photothermal conversion material and, optionally, a surfactant. It may be possible to use less of the photothermal conversion material if it is present in a separate absorber layer. The absorber layer preferably has a thickness sufficient to absorb at least 90%, preferably at least 99%, of the imaging radiation. Typically, the absorber layer has a coating weight of about 0.02 g/m² to about 2 g/m², preferably about 0.05 g/m² to about 1.5 g/m². Elements that comprise an absorber layer are disclosed in Shimazu, U.S. Pat. No. 6,593,055, the disclosure of which is incorporated herein by reference.

To minimize migration of the photothermal conversion material from the underlayer to the top layer during manufacture and storage of the imageable element, the element may comprise a barrier layer between the underlayer and the top layer. The barrier layer comprises a polymeric material that is soluble in the developer. If this polymeric material is different from the polymeric material in the underlayer, it is preferably soluble in at least one organic solvent in which the polymeric material in the underlayer is insoluble. A preferred polymeric material for the barrier layer is polyvinyl alcohol. When the polymeric material in the barrier layer is different from the polymeric material in the underlayer, the barrier layer should be less than about one-fifth as thick as the underlayer, preferably less than a tenth of the thickness of the underlayer. Imageable elements that comprise a barrier layer are disclosed in Patel, U.S. Pat. No. 6,723,490, the disclosure of which is incorporated herein by reference.

Substrate

The substrate comprises a support, which may be any material conventionally used to prepare imageable elements useful as lithographic printing plates. The support is preferably strong, stable, and flexible. It should resist dimensional change under conditions of use so that color records will register in a full-color image. Typically, it can be any self-supporting material, including, for example, polymeric films such as polyethylene terephthalate film, ceramics, metals, or stiff papers, or a lamination of any of these materials. Metal supports include aluminum, zinc, titanium, and alloys thereof.

Typically, polymeric films contain a sub-coating on one or both surfaces improve adhesion to subsequent layers. The nature of this layer or layers depends upon the substrate and the composition of subsequent layer or layers. Examples of subbing layer materials are adhesion-promoting materials, such as alkoxysilanes, aminopropyltriethoxysilane, glycidoxypropyltriethoxysilane and epoxy functional polymers, as well as conventional subbing materials used on polyester bases in photographic films.

When the substrate comprises a sheet of aluminum or an aluminum alloy, it should be of sufficient thickness to sustain the wear from printing and thin enough to wrap around a cylinder in a printing press, typically about 100 μm to about 600 μm. It is typically cleaned, roughened, and anodized by various methods known in the art. Initially, a degreasing treatment with a surfactant, an organic solvent, or an alkaline water solution is typically administered to the remove oil and grease from the surface of the sheet. Then the surface may be roughened by well known techniques, such as mechanical roughening, for example ball polishing, brush polishing, blast polishing and buff polishing, chemical roughening in which the surface is roughened by selectively dissolving the surface, or electrochemical roughening, or a combination of such chemical, mechanical, and/or electrochemical treatments (multi-graining). Etching of the substrate is performed using hot acidic (such as sulfuric or phosphoric) solutions or alkaline solutions (such as sodium hydroxide or trisodium phosphate mixed with sodium hydroxide). Anodic oxidation may be carried out to form a hydrophilic layer of aluminum oxide of the surface, typically a layer of aluminum oxide of at least 0.3 g/m² in weight. Anodic oxidation is performed by passing a current using the support as an anode in an electrolytic solution comprising an electrolyte, such as, for example, sulfuric acid, phosphoric acid, chromic acid, boric acid, citric acid, oxalic acid, or a mixture thereof. Anodic oxidation is disclosed, for example, in Fromson, U.S. Pat. No. 3,280,734 and Chu, U.S. Pat. No. 5,152,158.

Then, the cleaned, roughened, and anodized support may be hydrophilized with an alkali metal silicate, such as aqueous potassium silicate, lithium silicate, or, typically, sodium silicate. Hydrophilization is described, for example, in Jewett, U.S. Pat. No. 2,714,066 and Fromson, U.S. Pat. No. 3,181,461. The support is either immersed in or electrolyzed in an aqueous solution of the alkali metal silicate.

Typically, the substrate comprises an interlayer between the aluminum support and the overlying layer or layers. The interlayer may be formed by treatment of the aluminum support with, for example, silicate, dextrine, hexafluorosilicic acid, phosphate/fluoride, polyvinyl phosphonic acid (PVPA), vinyl phosphonic acid co-polymers, or a water-soluble diazo resin. Co-polymers that comprise (1) phosphonic acid groups and/or phosphate groups, and (2) acid groups and/or groups that comprise alkylene glycol or polyalkylene glycol side chains, which are useful as interlayer materials, are also disclosed in U.S. Patent Application Publication 2006/000401 (Hayashi et al.), the disclosure of which is incorporated herein by reference. Co-polymers that comprise (1) acid groups and/or phosphonic acid groups, and (2) silyl groups substituted with three alkoxy and/or phenoxy groups, useful as interlayer material, are disclosed in U.S. Pat. No. 7,049,048 (Hunter et al.), the disclosure of which is incorporated herein by reference.

The back side of the support (i.e., the side opposite the top layer and the underlayer) may be coated with an antistatic agent and/or a slipping layer or matte layer to improve handling and “feel” of the imageable element.

Preparation of the Imageable Element

The terms “solvent” and “coating solvent” include mixtures of solvents. These terms are used although some or all of the materials may be suspended or dispersed in the solvent rather than in solution. Selection of coating solvents depends on the nature of the components present in the various layers. The imageable element may be prepared by sequentially applying the underlayer over the hydrophilic surface of the substrate; applying the absorber layer or the barrier layer if present, over the underlayer; and then applying the top layer using conventional techniques.

The underlayer may be applied by any conventional method, such as coating or lamination. Typically the ingredients are dispersed or dissolved in a suitable coating solvent, and the resulting mixture coated by conventional methods, such as spin coating, bar coating, gravure coating, die coating, or roller coating. The underlayer may be applied, for example, from mixtures of methyl ethyl ketone, 1-methoxypropan-2-ol, γ-butyrolactone, and water; from mixtures of diethyl ketone, water, methyl lactate, and γ-butyrolactone; and from mixtures of diethyl ketone, water, and methyl lactate.

Preparation of imageable elements that comprise a barrier layer is disclosed in Patel, U.S. Pat. No. 6,723,490, the disclosure of which is incorporated herein by reference. Preparation of imageable elements that comprise an absorber layer is disclosed in Shimazu, U.S. Pat. No. 6,593,055, the disclosure of which is incorporated herein by reference. When neither a barrier layer nor an absorber layer is present, the top layer is coated on the underlayer. To prevent the underlayer from dissolving and mixing with the top layer, the top layer should be coated from a solvent in which the underlayer layer is essentially insoluble. Thus, the coating solvent for the top layer should be a solvent in which the components of the top layer are sufficiently soluble that the top layer can be formed and in which any underlying layers are essentially insoluble. Typically, the solvents used to coat the underlying layers are more polar than the solvent used to coat the top layer. The top layer may be applied, for example, from diethyl ketone and/or methyl isobutyl ketone, or from mixtures of diethyl ketone and/or methyl isobutyl ketone with 1-methoxy-2-propyl acetate. An intermediate drying step, i.e., drying the underlayer to remove coating solvent before coating the top layer over it, may also be used to prevent mixing of the layers.

Alternatively, the underlayer, the top layer, or both layers may be applied by conventional extrusion coating methods from a melt mixture of layer components. Typically, such a melt mixture contains no volatile organic solvents.

Imaging and Processing

The imageable elements may be thermally imaged with a laser or an array of lasers emitting modulated near infrared or infrared radiation in a wavelength region that is absorbed by the imageable element. Infrared radiation, especially infrared radiation in the range of about 700 nm to about 1200 nm, is typically used for imaging. Imaging is conveniently carried out with a laser emitting at about 830 nm, about 1056 nm, or about 1064 nm. Suitable commercially available imaging devices include image setters such as the CREO® Trendsetter (Eastman Kodak Company, Burnaby, British Columbia, Canada), the Screen PlateRite model 4300, model 8600, and model 8800 (Screen, Rolling Meadows, Chicago, Ill., USA), and the Gerber Crescent 42T (Gerber Systems, South Windsor, Conn., USA).

Alternatively, the imageable element may be thermally imaged using a hot body, such as a conventional apparatus containing a thermal printing head. A suitable apparatus includes at least one thermal head but would usually include a thermal head array, such as a TDK Model No. LV5416 used in thermal fax machines and sublimation printers, the GS618-400 thermal plotter (Oyo Instruments, Houston, Tex., USA), or the Model VP-3500 thermal printer (Seikosha America, Mahwah, N.J., USA).

Imaging produces an imaged element, which comprises a latent image of imaged (exposed) regions and complementary non-imaged (non-exposed) regions. Development of the imaged element to form a printing plate, or printing form, converts the latent image to an image by removing the imaged regions, revealing the hydrophilic surface of the underlying substrate.

The developer may be any liquid or solution that can penetrate and remove the exposed regions of the top layer, the underlying regions of, if present, the absorber layer or barrier layer, and the underlying regions of the underlayer without substantially affecting the complimentary non-exposed regions. Development is carried out for a long enough time to remove the exposed regions of the top layer, the underlying regions of, if present, the absorber layer or barrier layer, and the underlying regions of the underlayer in the developer, but not long enough to remove the non-exposed regions of the top layer. Hence, the exposed regions are described as being “soluble” or “removable” in the developer because they are removed, and dissolved and/or dispersed, more rapidly in the developer than the non-exposed regions. Typically, the underlayer is dissolved in the developer, the absorber layer is either dissolved or dispersed in the developer, and the top layer is dispersed in the developer.

Useful developers are aqueous solutions having a pH of about 7 or above. Common components of developers are surfactants; chelating agents, such as salts of ethylenediamine tetraacetic acid; organic solvents such as benzyl alcohol and phenoxyethanol; and alkaline components such as inorganic metasilicates, organic metasilicates, hydroxides or bicarbonates. Typical aqueous alkaline developers are those that have a pH between about 8 and about 13.5, typically at least about 11, preferably at least about 12.

The developer may comprise a surfactant or a mixture of surfactants. Preferred surfactants include: alkali metal salts of alkyl naphthalene sulfonates; alkali metal salts of the sulfate monoesters of aliphatic alcohols, typically having six to nine carbon atoms; and alkali metal sulfonates, typically having six to nine carbon atoms. A preferred alkali metal is sodium. The surfactant or mixture of surfactants typically comprises about 0.5 wt % to about 15 wt % based on the weight of the developer, preferably about 3 wt % to about 8 wt %, based on the weight of the developer. As is well known to those skilled in the art, many surfactants are supplied as aqueous surfactant solutions. These percentages are based on the amount of surfactant (i.e. the amount of active ingredient or ingredients exclusive of water and other inactive materials in the surfactant solution) in the developer.

A developer may comprise a buffer system to keep the pH relatively constant, typically between about 5.0 and about 12.0, preferably between about 6.0 and about 11.0, more preferably between about 8.0 and about 10.0. Numerous buffer systems are known to those skilled in the art. Typically buffer systems include, for example: combinations of water-soluble amines, such as mono-ethanol amine, diethanol amine, tri-ethanol amine, or tri-i-propyl amine, with a sulfonic acid, such as benzene sulfonic acid or 4-toluene sulfonic acid; mixtures of the tetra sodium salt of ethylene diamine tetracetic acid (EDTA) and EDTA; mixtures of phosphate salts, such as mixtures of mono-alkali phosphate salts with tri-alkali phosphate salts; and mixtures of alkali borates and boric acid. Water typically comprises the balance of the developer.

Some developers contain one or more organic solvents. Such developers comprise an organic solvent or a mixture of organic solvents. The developer is a single phase. Consequently, the organic solvent must be miscible with water, or at least soluble in the developer to the extent it is added to the developer, so that phase separation does not occur. The following solvents and mixtures of these solvents are suitable for use in the developer: the reaction products of phenol with ethylene oxide and propylene oxide, such as ethylene glycol phenyl ether (phenoxyethanol); benzyl alcohol; esters of ethylene glycol and of propylene glycol with acids having six or fewer carbon atoms, and ethers of ethylene glycol, diethylene glycol, and of propylene glycol with alkyl groups having six or fewer carbon atoms, such as 2-ethylethanol and 2-butoxyethanol. A single organic solvent or a mixture of organic solvents can be used. The organic solvent is typically present in the developer at a concentration of between about 0.5 wt % to about 15 wt %, based on the weight of the developer, preferably between about 3 wt % and about 5 wt %, based on the weight of the developer. Such organic solvent-containing developers generally have a pH of from about 6.5 to about 11 and preferably from about 6.5 to about 8.5.

Useful commercially available solvent-based developers include ND-1 Developer, 956 Developer and 955 Developer (Eastman Kodak Company). Developers consisting of 1 part ND-1 Developer and 3 to 5 parts of water are also useful. Another useful solvent-based developer is identified below as Developer A and is a mixture of 726.39 parts water, 6.64 parts monoethanolamine, 34.44 parts diethanolamine, 177.17 parts PELEX® NB-L (sodium alkyl naphthalene sulfonate anionic surfactant, Kao Corp., Chuo-ku, Tokyo, Japan), and 55.36 parts benzyl alcohol. Other useful developers are aqueous alkaline developers, such as 3000 Developer and 9000 Developer (Eastman Kodak Company).

The developer is typically applied to the precursor by spraying the element with sufficient force to remove the exposed regions. Alternatively, development may carried out in a processor equipped with an immersion-type developing bath, a section for rinsing with water, a gumming section, a drying section, and a conductivity-measuring unit, or the imaged precursor may be brushed with the developer. In each instance, a printing plate is produced. Development may conveniently be carried out in a commercially available spray-on processor, such as an 85 NS (Kodak Polychrome Graphics) or in a commercially available immersion-type processor such as the PK910 Mark II Processor (Kodak Polychrome Graphics).

Following development, the printing plate is rinsed with water and dried. Drying may be conveniently carried out by infrared radiators or with hot air. After drying, the printing plate may be treated with a gumming solution. A gumming solution comprises one or more water-soluble polymers, for example cellulose, polyvinylalcohol, polymethacrylic acid, polymethacrylamide, polyvinylmethylether, polyhydroxyethylmethacrylate, gelatin, and polysaccharide such as dextran, pullulan, gum arabic, and alginic acid. A preferred material is gum arabic.

A developed and gummed plate may also be baked to increase the run length of the plate. Baking can be carried out, for example at about 220° C. to about 240° C. for about 7 minutes to 10 minutes, or at a temperature of 120° C. for 30 minutes.

### INDUSTRIAL APPLICABLITY

The imageable elements of the invention have excellent resistance to press room chemicals and solvents encountered in printing. They can be thermally imaged and developed to form lithographic printing plates. Once the imageable element has been imaged and developed to form a lithographic printing plate, printing can then be carried out by applying a fountain solution and lithographic ink to the image on its surface. The fountain solution is taken up by the surface of the hydrophilic substrate revealed by the imaging and development process, and the ink is taken up by the regions of the layers not removed by the development process. The ink is then transferred to a suitable receiving material (such as cloth, paper, metal, glass or plastic) either directly or indirectly using an offset printing blanket to provide a desired impression of the image thereon.

The advantageous properties of this invention can be observed by reference to the following examples, which illustrate but do not limit the invention.

### EXAMPLES

### Glossary

956 Developer Solvent based (phenoxyethanol) alkaline negative developer (Eastman Kodak Company)
AIBN 2,2′-Azobisisobutyronitrile (Vazo-64, DuPont, Wilmington, Del.)
BC 2-Butoxyethanol (Butyl CELLOSOLVE®) (80 vol % in water)
Byk® 307 Polyethoxylated dimethylpolysiloxane co-polymer (BYK Chemie, Wallingford, Conn.)
CREO® Trendsetter 3244x Commercially available platesetter, using Procom Plus software and having a laser diode array emitting at 830 nm (Eastman Kodak Company, Burnaby, BC, Canada)
DAA Diacetone alcohol (80 vol % in water)
Developer A1 1 part ND-1 negative developer and 4 parts water
Ethyl violet C.I. 42600; CAS 2390-59-2 (λₘₐₓ=596 nm) [(p-(CH₃CH₂)₂NC₆H₄)₃C⁺Cl⁻] (Aldrich Chemical Co., Milwaukee, Wis.)
IR Dye A Infrared absorbing dye (λₘₐₓ=830 nm) (Eastman Kodak, Rochester, N.Y.) (see structure above)
IR Dye B Infrared absorbing dye (Eastman Kodak Company) (see structure above)
IR Dye C Infrared absorbing dye (Honeywell, Morristown, N.J.) (see structure above)
ND-1 Negative developer (Eastman Kodak Company)
Pyromellitic anhydride As supplied by Aldrich Chemical Company
Pelex® NBL Sodium butyl naphthalene sulfonate solution available from Kao Corporation (Tokyo, Japan)
Polymer A Co-polymer of N-phenylmaleimide (41.5 mol %), methacrylamide (37.5 mol %), and methacrylic acid (21 mol %).
Polymer B A copolymer of N-phenylmaleimide 40 mol %, methacrylamide 35 mol % and methacrylic acid 25 mol % (Clariant, Germany)
Polymer 1 Poly(styrene-maleic anhydride), Mw 224,000 (Aldrich Chemical Co.)
Polymer 2 Poly(styrene-maleic anhydride) cumene terminated, Mw 1,600 (Aldrich Chemical Co.)
Polymer 3 Poly(styrene-maleic anhydride) cumene terminated, Mw 1,700 (Aldrich Chemical Co.)
Polymer 4 Poly(styrene-maleic anhydride) cumene terminated, Mw 1,900 (Aldrich Chemical Co.)
Polymer 5 Poly(4-acetoxystyrene-maleic anhydride) (synthesis below)
RX-04 A styrene/maleic anhydride copolymer as supplied by Gifu Shellac (Japan).
Substrate A 0.3 mm gauge, aluminum sheet which had been electrograined, anodized and treated with a solution of polyvinyl phosphonic acid
SWORD® Excel™ Thermally sensitive, positive working, multi-layer, printing plate precursor (Eastman Kodak Company)

Developer A2 comprised water 6 parts, and 1 part of following components, by weight:

| Raw materials to make 1 Kg | |
|---|---|
| Water | 726.39 g |
| Monoethanolamine | 6.64 g |
| Diethanolamine (99%) | 34.44 g |
| Pelex NBL (35%) | 177.17 g |
| Benzyl alcohol | 55.36 g |

Synthesis of Polymer H:

Polymer H was an N-phenylmaleimide/methacrylamide/methacrylic acid copolymer that was prepared as follows:

55.37 g of N-phenylmaleimide, 24.35 g of methacrylamide, 20.28 g of methacrylic acid, 132 g of 1,3-dioxolane, and 100 g of ethanol were charged to a four-necked reaction kettle equipped with a thermometer, condenser, stirrer and nitrogen inlet. The reaction mixture was heated to about 60° C. under a nitrogen atmosphere and stirred for 1 hour. 0.1 g AIBN was added and the polymerization was allowed to proceed for 20 hours. The polymer was precipitated into 2 liters of water acidified with 5 drops of hydrochloric acid and then filtered. The polymer was then washed in 1000 ml of ethanol/water (80/20) and filtered again before placing in an oven and drying to constant weight at 50° C.

Synthesis of Polymer 5:

A 500 ml reaction vessel was fitted with a heating mantle, stirrer, thermometer, condenser, and nitrogen atmosphere. A mixture of maleic anhydride (15.07 g), 4-acetoxystyrene (24.93 g), and 96 g of dry dioxolane was added to the vessel and heated to 60° C. under a nitrogen atmosphere. Nitrogen was bubbled through the mixture for 1 h. Then the nitrogen inlet was removed from the mixture, and 1.01 g of AIBN were added. The reaction mixture was heated under nitrogen for 8 hours at 60° C. The reaction mixture was cooled to room temperature, and the resulting copolymer was isolated by pouring the reaction mixture into 2 liters of diethylether/hexane (50/50 by volume). The copolymer was filtered off, washed several times with diethylether/hexane and dried for 48 hours at 50° C. Yield: 37 g of Polymer 5.

Synthesis of Polymer 6:

Polymer 6 (1.72 g, 4% yield) derived from 50 mol % styrene and 50 mol % 2,3-dimethylmaleic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: 2,3-dimethylmaleic anhydride (21.91 g), 1,3-dioxolane (452.09 g).
3. Prepared styrene mix solution: diluted 18.09 g of styrene with 41.91 g of 1,3-dioxolane. Add three grams of this solution was added to the reaction vessel at time zero.
4. Furnished a nitrogen supply to the reaction solution by attaching nitrogen bubbler to the inlet. Connected the nitrogen outlet (top of condenser) to a Drechel bottle and maintained positive nitrogen pressure. Raised temperature to 60-65° C.
5. Added 1.70 grams of 1% AIBN (in dioxolane) solution to the reaction mixture. Repeated this step every hour.
6. Added 1.5 grams of prepared styrene mix solution from step #3 to the reaction mixture. Repeated this step every one half hour until reaction completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to methanol to form a precipitate that was filtered and washed with methanol and filtered again.
10. Dried for 2 days at 40° C.
   Synthesis of Polymer 7:

Polymer 7 (7.97 g, 20% yield) derived from 50 mol % styrene and 50 mol % citraconic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: citraconic anhydride (20.73 g), 1,3-dioxolane (453.27 g).
3. Prepared styrene mix solution: diluted 19.27 g of styrene with 40.73 g of 1,3-dioxolane. Added three grams of this solution into the reaction vessel at time zero.
4. Furnished a nitrogen supply to the reaction solution by attaching a nitrogen bubbler to the inlet. Connected the nitrogen outlet (top of condenser) to a Drechel bottle and maintained positive nitrogen pressure. Raised temperature to 60-65° C.
5. Added 1.70 grams of 1% AIBN (in Dioxolane) solution to the reaction mixture. Repeated this step every hour.
6. Added 1.5 grams of the prepared styrene mix solution from step #3 to the reaction mixture. Repeated this step every one half hour until completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to methanol to form precipitate that was filtered and washed with methanol and filtered again.
10. Dried for 2 days at 40° C.
   Synthesis of Polymer 8:

Polymer 8 (34.68 g, 87% yield) derived from 45 mol % Styrene, 5 mol % 4-methylstyrene, and 50 mol % maleic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: maleic anhydride (19.26 g) and 1,3-dioxolane (454.6 g).
3. Prepared styrene mix solution: dilute 18.41 g of styrene and 2.32 g of 4-methylstyrene with 39.40 g of 1,3-Dioxolane. Added three grams of this solution to the reaction vessel at time zero.
4. Furnished a nitrogen supply to the reaction solution by attaching nitrogen bubbler to the inlet. Connected the nitrogen outlet (top of condenser) to a Drechel bottle and maintained positive nitrogen pressure. Raised temperature to 60-65° C.
5. Added 1.70 grams of 1% AIBN (in Dioxolane) solution to the reaction mixture. Repeated this step every hour.
6. Added 1.5 grams of prepared styrene mix solution from step #3 to the reaction mixture. Repeated this step every one half hour until complete.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to ether to form a precipitate that was filtered and washed with ether and filtered again.
10. Dried for 2 days at 40° C.
   Synthesis of Polymer 9:

Polymer 9 (38.47 g, 96% yield) derived from 45 mol % styrene, 5 mol % α-methylstyrene and 50 mol % maleic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: maleic anhydride (19.26 g) and 1,3-dioxolane (454.6 g).
3. Prepared a styrene mix solution: diluted 18.41 g of styrene and 2.32 g of α-methylstyrene with 39.40 g of 1,3-dioxolane. Added three grams of this solution into the reaction vessel at time zero.
4. Furnished a nitrogen supply to the reaction solution by attaching nitrogen bubbler to the inlet. Connected the nitrogen outlet (top of condenser) to a Drechel bottle and maintained positive nitrogen pressure. Raised temperature to 60-65° C.
5. Added 1.70 grams of 1% AIBN (in dioxolane) solution to the reaction mixture. Repeated this step every hour.
6. Added 1.5 grams of prepared styrene mix solution from step #3 to the reaction mixture. Repeated this step every one half hour until completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to ether to form a precipitate that was filtered and washed with ether and filtered again.
10. Dried for 2 days at 40° C.
   Synthesis of Polymer 10:

Polymer 10 (31.43 g, 79% yield) derived from 45 mol % styrene, 5 mol % β-methylstyrene and 50 mol % maleic anhydride was synthesized as follows:

1. Equipped a four neck round bottom flask (1000 ml) with a condenser, a nitrogen supply, a thermometer, a stirrer, and a heating mantle.
2. Placed all reactants into the reaction vessel: maleic anhydride (19.26 g) and 1,3-dioxolane (454.6 g).
3. Prepared a styrene mix solution: diluted 18.41 g of styrene and 2.32 g of β-methylstyrene with 39.40 g of 1,3-dioxolane. Added three grams of this solution into the reaction vessel at time zero.
4. Furnished a nitrogen supply to the reaction solution by attaching nitrogen bubbler to the inlet. Connected the nitrogen outlet (top of condenser) to a Drechel bottle and maintained positive nitrogen pressure. Raised the temperature to 60-65° C.
5. Added 1.70 grams of 1% AIBN (in dioxolane) solution to the reaction mixture. Repeated this step every hour.
6. Added 1.5 grams of the prepared styrene mix solution from step #3 to the reaction mixture. Repeated this step every one half hour until completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to ether to form a precipitate that was filtered and washed with ether and filtered again.
10. Dried for 2 days at 40° C.
   Synthesis of Polymer 11:

Polymer 11 (38.47 g, 96% yield) derived from 40 mol % styrene, 10 mol % α-methylstyrene and 50 mol % maleic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: maleic anhydride (19.13 g) and 1,3-dioxolane (454.6 g).
3. Prepared a styrene mix solution: diluted 16.26 g of styrene and 4.61 g of α-methylstyrene with 39.40 g of 1,3-dioxolane. Added three grams of this solution into the reaction vessel at time zero.
4. Furnished a nitrogen supply to the reaction solution by attaching a nitrogen bubbler to the inlet. Connected the nitrogen outlet (top of condenser) to a Drechel bottle and maintained positive nitrogen pressure. Raised temperature to 60-65° C.
5. Added 1.70 grams of 1% AIBN (in dioxolane) solution to the reaction mixture. Repeated this step every hour.
6. Added 1.5 grams of the prepared styrene mix solution from step #3 to the reaction mixture. Repeated this step every one half hour until completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to ether to form precipitate that was filtered and washed with ether and filtered again.
10. Dried for 2 days at 40° C.
   Synthesis of Polymer 12:

Polymer 12 (29.86 g, 75% yield) derived from 66.67 mol % styrene and 33.33 mol % maleic anhydride was synthesized as follows:
1. Equipped a four neck round bottom flask (1000 ml) with a condenser, a nitrogen supply, a thermometer, a stirrer, and a heating mantle.
2. Placed all reactants into the reaction vessel: styrene (5.15 g), maleic anhydride (12.80 g), and 1,3-dioxolane (456.05 g).
3. Prepared a styrene mix solution: diluted 22.05 g of styrene with 37.95 g of 1,3-dioxolane. Added three grams of this solution into the reaction vessel at time zero.
4. Furnished a nitrogen supply to the reaction solution by attaching a nitrogen bubbler to the inlet. Connected the nitrogen outlet (top of condenser) to a Drechel bottle and maintained positive nitrogen pressure. Raised temperature to 60-65° C.
5. Added 3.4 g of 1 % AIBN (in dioxolane) solution to the reaction mixture. Repeated this step every hour.
6. Added 1.5 grams of the prepared styrene mix solution from step #3 to the reaction mixture. Repeated this step every one half hour until completed.
7. Stirred the reaction mixture for 20 hours, maintaining a constant 60-65° C. under nitrogen.
8. Stripped excess solvent (approx. 300 g) from the polymer solution through distillation.
9. Isolated the polymer by precipitation. The polymer solution was added slowly, with stirring, to ether to form precipitate that was filtered and washed with ether and filtered again.
10. Dried for 2 days at 40° C.

### General Procedures

### Preparation of Imageable Elements

Imageable elements were Prepared by the Following Procedure.

Underlaver: A coating solution containing 6.5 wt % of a mixture of 84.5 wt % of Polymer A, 15 wt % of IR Dye A, and 0.5 wt % of Byk® 307 in a mixture of 2-butanone/1-methoxy-2-propanol/γ-butyrolactone/water (65:15:10:10 by weight) was coated onto Substrate A using a 0.03 in wire wound bar, and the resulting element dried at 135° C. for 35 seconds. The coating weight of the underlayer was 1.5 g/m².

Top layer: A coating solution containing 7.1 wt % of a mixture of 99.1 wt % of co-polymer, 0.4 wt % of ethyl violet, and 0.5 wt % of Byk® 307 in diethylketone/1-methoxy-2-propanol acetate (92:8, v:v) was coated onto the underlayer using a 0.006 in wire wound bar, and the resulting imageable element dried at 135° C. for 35 seconds. The coating weight of the top layer was 0.7 g/m².

### Evaluation Procedures

Developer Drop Test: A large drop of Developer A1 was placed on the surface of the top layer at 30 second intervals at 22° C. up to 5 minutes. The time of the first visible signs of developer attack and the time to completely remove the top layer were recorded.

Solvent Resistance Test: A large drop of either BC (2-butoxyethanol, 80 vol % in water) or DAA (diacetone alcohol, 80 vol % in water) was placed on the surface of the top layer at 2 minute intervals at 22° C. up to 16 minutes. The time at which damage to the top layer occurred was observed. The amount of the top layer removed was assessed (1=no removal; 10=complete removal).

Imaging and Processing Tests: The imageable element was thermally imaged on a CREO® Trendsetter 3244 at 8 watts using plot 0 and plot 12 internal test patterns. The imaging energies were 136, 115, 100, 88, and 79 mJ/cm². The resulting imaged imageable element developed at 30° C. in a PK910II processor (Eastman Kodak Company) using Developer A and an immersion time of 12 sec. The resulting lithographic printing plates were evaluated for cleanout (lowest imaging energy at which the imaged regions are completely removed by the developer), and best resolution (imaging energy at which printing plate performs best).

Baking Test: A 2×10 inch strip of the imageable element was placed in a Mathis Labdryer oven with a fan speed of 1000 rpm for 8 minutes at 230° C. Positive image remover PE3S (Kodak Polychrome Graphics, Japan Ltd) was applied to the imageable element at 30 second intervals up to 5 min. The imageable elements were rinsed immediately, and the time for the image remover to layers noted.

### Example 1-4 and Comparative Example 1

Imageable elements containing styrene/maleic anhydride co-polymers were prepared and evaluated as described above. Comparative Example 1 (C1) is a SWORD® Excel™ thermally sensitive, positive working, multi-layer, printing plate precursor. The results are shown in Tables 1 and 2.

TABLE 1

| | | | | Imaging | |
|---|---|---|---|---|---|
| | | Developer Drop | | and Processing | |
| | | Test | | (mJ/cm2) | |
| | | | Top Layer | | Best |
| Example | Polymer | First attack | Removed | Cleanout | Resolution |
| 1 | Polymer 1 | 100 sec | >300 sec | —^{a} | —^{a} |
| 2 | Polymer 2 | 180 sec | >300 sec | 86 | 115 |
| 3 | Polymer 3 | 120 sec | >300 sec | 86 | 115 |
| 4 | Polymer 4 | 150 sec | >300 sec | 86 | 115 |
| C1^{b} | —^{b} | 180 sec | >300 sec | 86 | 115 |

^{a}Imageable element doesn't process properly.
^{b}SWORD ® Excel ™ printing plate precursor.

TABLE 2

| | BC Solvent Resistance Test | | | | |
|---|---|---|---|---|---|
| Example | 2 min | 4 min | 6 min | 8 min | 16 min |
| 1 | 1 | 1 | 1 | 1 | 1 |
| 2 | 1 | 1 | 1 | 1 | 1 |
| 3 | 1 | 1 | 1 | 1 | 1 |
| 4 | 1 | 1 | 1 | 1 | 1 |
| C1 | 10 | 10 | 10 | 10 | 10 |

TABLE 3

| | DAA Solvent Resistance Test | | | | |
|---|---|---|---|---|---|
| Example | 2 min | 4 min | 6 min | 8 min | 16 min |
| 1 | 1 | 1 | 1 | 1 | 1 |
| 2 | 1 | 1 | 1 | 2 | 2 |
| 3 | | 1 | 1 | 1 | 2 |
| 4 | 1 | 1 | 1 | 1 | 1 |
| C1 | 10 | 10 | 10 | 10 | 10 |

### Example 5

Imageable elements from Example 2 were placed in a humidity chamber at 40° C. and 80% relative humidity for 1, 3, 7 and 10 days. The aged imageable elements and an imageable element that had not been aged were evaluated as described above, except that imaging energies of 126, 119, 112, 105, 100, 95, 90, 86, 82 and 79 mJ/cm² were used in the imaging and processing tests. The results are given in Table 4.

TABLE 4

| | | | |
|---|---|---|---|
| | | | Exposure for |
| | Developer | Cleanout | best resolution |
| Days Aged | Drop Test | Energy (mJ/cm²) | (mJ/cm²) |

| | | | |
|---|---|---|---|
| 0 | 210 sec | 86 | 126 |
| 1 | 240 sec | 90 | 126 |
| 3 | 210 sec | 86 | 126 |
| 7 | 240 sec | 86 | 126 |
| 10 | 150 sec | 86 | 119 |

### Examples 6 and 7

Imageable elements prepared using styrene/maleic anhydride Polymer 2 and Polymer 5 in the top layer were evaluated as described in the General Procedures, except that 956 Developer was used in the developer drop test. The results are given in Table 5. Example 7 required more mechanical agitation in order to completely process the imaged imageable element. This was achieved by increasing the pressure of the plush rollers in the processor.

TABLE 5

| | | | | Exposure | |
|---|---|---|---|---|---|
| | | | | for Best | |
| | | Developer | Cleanout | Resolution | |
| Example | Polymer | Drop Test | (mJ/cm²) | (mJ/cm²) | Baking test |
| 6 | Polymer 2 | 90 | <86 | 100 | <30 sec |
| 7 | Polymer 5 | 120 | <86 | 115 | 3 min |

The top layer containing Polymer 5 was able to resist deletion up to 3 min. This indicated that some degree of cross-linking had occurred in the coating. Cross-linked coatings provide better run-length on press.

### Example 8

An imageable element was prepared by coating two organic layers onto Substrate A. The first coating (basecoat) was applied to Substrate A with a 0.012 inch wire-wound bar. The coating was applied as a 7.0% solution from a mixture of methylethylketone/1-methoxy-2-propanol/butyrolactone/water (50:30:10:10 by weight) to produce a dry coat weight of 1.5 g/m². It was dried at a temperature of 125° C. for 35 seconds. The first coating had the following formula:

| Component | Parts by weight |
|---|---|
| Polymer H | 84.3 |
| IR Dye A | 15 |
| BYK ® 307 | 0.7 |

The second organic coating (top layer) was applied on top of the basecoat with a 0.006 inch wire-wound bar. The coating was applied as a 6.0% solution from a mixture of diethylketone/1-methoxy-2-propanol acetate (92:8 w/w) to produce a dry coat weight of 0.6 g/m². It was dried at a temperature of 125° C. for 35 seconds. The second coating contained 100 parts by weight of RX-04.

Tests:

The imageable element was subject to the following tests.

i) Developer Drop Test, Basecoat Only Sample:

Drops of ‘Developer A2’ were placed onto a sample, onto which only basecoat had been coated. The drops were applied at 2-second intervals up to 20 seconds and then rinsed immediately with water. The time taken for the developer to completely remove the basecoat was recorded.

ii) Developer Drop Test, Topcoated Sample:

Drops of ‘Developer A2’ were placed onto a sample of the imageable element. The drops were applied at 20-second intervals up to 120 seconds and then rinsed immediately with water. The time taken for the developer to start attacking the coating was recorded.

iii) Imaging and Processing Tests:

The imageable elements were imagewise exposed with 830 nm radiation on a Creo® 3244 Trendsetter. The ‘Plot 0’ internal test pattern was applied at 8 watts with exposure energies of 162, 144, 129, 117, 108, 99, 92, 86, 81 and 78 mJ/cm².

The imaged elements were developed in a Kodak Polychrome Graphics PK910II processor using Developer A2 at 30° C. with an immersion time of 12 seconds. The resulting printing plates were evaluated for cleanout (lowest energy where exposed areas are completely removed by developer), and best resolution (imaging energy at which plate performs best).

iv) A sample of the imaging element was imaged at 144 mJ/cm² with a file that contained suitable image for printing tests. The sample was processed as above and mounted on a Komori Sprint II 28 inch lithographic printing press. 1200 impressions were printed.

The following results were observed from the four tests:
i) The developer took 10 seconds to dissolve in the basecoat.
ii) No attack from the developer was seen on the topcoat, even after 2 minutes.
iii) The imaging element was processed quickly and easily in the PK910II processor. Cleanout energy was 92 mJ/cm² and the best resolution was produced at an exposure of 144 mJ/cm², at which excellent images at high resolution were produced.
iv) The imaging element had excellent printability. It printed high-resolution images and rolled up to full ink density in less than 5 sheets.

### Examples 9-11

For each of these examples, an underlayer formulation was applied to Substrate A using a 0.012 inch wire-wound bar to produce a dry film weight of about 1.5 g/m². The formulation was applied as a 7.0% solution from a mixture of methylethylketone/1-methoxy-2-propanol/butyrolactone/water (50:30:10:10 by weight) and dried at a temperature of about 135° C. for 35 seconds. The formulation contained the following components:

| Component | Parts by weight |
|---|---|
| Polymer B | 77.85 |
| IR dye C | 10 |
| IR Dye B | 8 |
| Pyromellitic anhydride | 3.5 |
| Byk ® 307 | 0.65 |

The following topcoat formulations were prepared and used at a concentration of 6.0% w/w by dissolving the components (parts by weight) in a mixture of diethylketone/1methoxy-2-propanol acetate (92:8 w/w).

| | | | | Polymer | Ethyl | Byk ® |
|---|---|---|---|---|---|---|
| Example | RX-04 | Polymer 8 | Polymer 9 | 10 | Violet | 307 |
| C2 | 99.0 | | | | 0.2 | 0.8 |
| 9 | | 99.0 | | | 0.2 | 0.8 |
| 10 | | | 99.0 | | 0.2 | 0.8 |
| 11 | | | | 99.0 | 0.2 | 0.8 |

The topcoat formulations were applied to the dried underlayer using a 0.006 in wire wound bar and dried at about 135° C. for 35 seconds. The dry coating weight was approximately 0.6 g/m².

The resulting imageable elements [Comparative Example 2 (C2) and Examples 9-11] were evaluated using the following tests.

i). Developer Drop Test:

A large drop of Developer A2 was placed on each imageable element at 20-second intervals up to 5 minutes at 22° C. The first visible signs of developer attack and the time taken to completely remove the topcoat were recorded.

ii). Imaging and Processing Tests:

The imageable elements were exposed with 808 nm radiation on a Screen PTR4300 platesetter. The Comparative Example 2 internal test pattern was used to plot a power series at a drum speed of 1000 rpm. A total of nine plot patterns were exposed at powers of 50% to 90% with increments of 5%.

Exposed elements were then developed in a Kodak Polychrome Graphics PK910II processor using Developer A2 at 30° C. with an immersion time of 12 seconds. The resulting printing plates were evaluated for cleanout (lowest energy where exposed areas are completely removed by developer), and the best resolution (imaging energy at which plate performs best).

All imageable elements produced high-resolution images that were developed quickly and easily through the PK910II processor.

| | | | Screen PTR4300 | |
|---|---|---|---|---|
| | | | Exposure | |
| | | | Series (% power) | |
| | Developer A2 - Drop Tests | | | Best |
| Example | First attack | Coating Removed | Cleanout | Resolution |
| C2 | >120 sec | >300 sec | 80 | 90 |
| 9 | >120 sec | >300 sec | 75 | 85 |
| 10 | >120 sec | >300 sec | 75 | 85 |
| 11 | 100 sec | >300 sec | 75 | 85 |

The invention has been described in detail with particular reference to certain preferred embodiments thereof, but it will be understood that variations and modifications can be effected within the spirit and scope of the invention.

1. A positive-working imageable element comprising a photothermal conversion material, a substrate, an underlayer over the substrate that is removable by an alkaline developer, and an ink receptive top layer over said underlayer, in which:
before thermal imaging, said top layer is dissolvable in an alkaline developer much more slowly than said underlayer,
after thermal imaging to form exposed and non-exposed regions in said element, said exposed regions are more removable by said alkaline developer than said non-exposed regions, and
said top layer comprises a polymeric material comprising recurring units comprising an anhydride, said polymeric material being present in an amount of at least 60 weight % based on topcoat layer dry weight.

2. The element of claim 1 wherein said top layer polymeric material is present in an amount of at least 75 weight % based on top layer dry weight.

3. The element of claim 1 wherein said top layer polymeric material is present in an amount of at least 90 weight % based on top layer dry weight.

4. The element of claim 1 wherein said top layer polymeric material is present as the sole polymeric binder in said top layer.

5. The element of claim 1 wherein said top layer polymeric material comprises recurring units derived from maleic anhydride or a substituted maleic anhydride and styrene or a styrene derivative.

6. The element of claim 5 wherein said top layer polymeric material is a co-polymer of maleic anhydride or a substituted maleic anhydride with one or more monomers of the formula CHR═CR¹(C₆H₄R²) in which R and R¹ are independently hydrogen or an alkyl group having 1 to 6 carbon atoms, and R² is hydrogen, halogen, hydroxyl, cyano, sulfonamide, alkyl of 1 to 6 carbon atoms, alkoxyl of 1 to 6 carbon atoms, acyl of 1 to 7 carbon atoms, acyloxy of 1 to 7 carbon atoms, carboalkoxy of 1 to 7 carbon atoms, or a mixture thereof.

7. The element of claim 6 wherein R, R¹, and R² are independently hydrogen or methyl.

8. The element of claim 1 wherein said top layer polymeric material comprises from about 40 to about 60 mol % of recurring units derived from maleic anhydride, based on total recurring units, and the remaining recurring units are derived from styrene or methylstyrene, and said top layer polymeric material is present in an amount of at least 95 weight %, based on dry top layer weight.

9. The element of claim 1 in which said top layer further comprises one or more surfactants, one or more colorants, or both one or more surfactants and one or more colorant.

10. The element of claim 1 wherein said underlayer comprises said photothermal conversion material.

11. The element of claim 1 wherein said top layer is essentially free of said photothermal conversion material.

12. A method for forming a lithographic printing plate comprising:
(A) imagewise exposing the positive-working imageable element of claim 1 to form exposed and non-exposed regions,
(B) contacting the imaged imageable element with an alkaline developer to remove selectively said exposed regions.

13. The method of claim 12 in which said developer is an organic solvent-containing developer having a pH less than 11.

14. The method of claim 13 wherein said organic solvent-containing developer comprises benzyl alcohol, 2-phenoxyethanol, or a combination thereof.

15. The method of claim 13 wherein said developer comprises one or more surfactants and a pH of from about 6.5 to about 10.5.

16. The method of claim 12 wherein said imagewise exposure is carried out using an infrared laser.

17. The method of claim 12 wherein the top layer polymeric material is present in said top layer in an amount of at least 90 weight % based on top layer dry weight and said underlayer comprises said photothermal conversion material.

18. The method of claim 12 wherein said top layer polymeric material is a co-polymer of maleic anhydride or a substituted maleic anhydride with one or more monomers of the formula CHR═CR¹(C₆H₄R²) in which R and R¹ are independently hydrogen or an alkyl group having 1 to 6 carbon atoms, and R² is hydrogen, halogen, hydroxyl, cyano, sulfonamide, alkyl of 1 to 6 carbon atoms, alkoxyl of 1 to 6 carbon atoms, acyl of 1 to 7 carbon atoms, acyloxy of 1 to 7 carbon atoms, carboalkoxy of 1 to 7 carbon atoms, or a mixture thereof.

19. A lithographic printing plate obtained by the method of claim 12.
